(19) United States
(12) Patent Application Publication
(10) Pub. No.: US 2004/0230371 A1
(43) Pub. Date: Nov. 18, 2004

(54) System and method for creation and display of information associated with spatial-temporal attributes

(75) Inventors: David M. Vincent, Vancouver (CA); Paul K. Melhus, Vancouver (CA); Daniel S. Parlow, Vancouver (CA); Faye D. Parlow, Vancouver (CA)

Correspondence Address: DAVIS WRIGHT TREMAINE, LLP, 2600 CENTURY SQUARE, 1501 FOURTH AVENUE, SEATTLE, WA, 98101-1688, US

(73) Assignee: GroupInfoWeb.com, Inc., Vancouver (CA)

(21) Appl. No.: 10/758,941

(22) Filed: Jan. 16, 2004

Related U.S. Application Data
(60) Provisional application No. 60/440,370, filed on Jan. 16, 2003.

(51) Int. Cl. G01C 21/34

(52) U.S. Cl. 701/200; 701/211; 340/995.1

(57) ABSTRACT

The invention describes a system and method whereby a traveler connected to the Internet can create a trip journal with a series of user-created points on a raster based map and a time-stamped annotation associated with each point. The individual user-created points and their associated annotations are linked based on their temporal attributes to show time-based progression from location to location. The relative location of the points along the route is displayed consistently, regardless of the scale or view of the map where the data is displayed. The system includes a database of maps and a user interface that allows travelers to select and customize maps; create and annotate entries with pictorial and textual information; assign a temporal attribute to an entry; associate an entry with a point on a chosen map; and display the resultant information to others. In addition, the traveler can update their entries at any time with the resultant changes displayed in real time.

### CROSS REFERENCE TO RELATED APPLICATION(S)

This application claims the benefit of U.S. application No. 60/440,370 filed Jan. 16, 2003 which is hereby incorporated by reference.

### BACKGROUND OF THE INVENTION

Modern geographic information systems (GIS) normally use digital vector data to generate maps. In an Internet based environment, when a remote user requests a particular map, the GIS fetches a mathematical description of the map from a server. The mathematical description, including data points, can then be transmitted through the Internet to a remote computer which has a computer program installed to allow the map to be viewed (for example as described in U.S. Pat. No. 6,337,693 to Roy et al., entitled Vector-based Geographic Data). This system is an efficient way to transmit map data, but requires the map viewing software to be installed on the remote computer. The remote computer may not be sufficiently powerful to run the necessary software or it may have an incompatible operating system. It also may not be possible to install new software on the remote computer (for example if the remote location was in an Internet café).

Alternate systems using raster based maps (for example as described in U.S. Pat. 6,282,489 to Bellesfield, et al., entitled Methods and Apparatus for Displaying a Travel Route and Generating a List of Places of Interest Located Near the Travel Route) have been developed. Sending raster data as a .jpg file through the Internet works well because the information can be displayed on any computer running a standard web browser such as Internet Explorer™ available from Microsoft™ Corporation. However, this method does not allow the user to customize the maps and modify or annotate the travel route.

Simply storing a set of maps as raster images may also cause difficulties. While raster based images are efficient for Internet use—delivering them to a remote user requires minimal overhead for both the server and the remote computer, there is no inherent relationship between maps. Each image is just a separate collection of dots. Thus scaling beyond certain narrow limits introduces unacceptable grain to the image; points placed on one map view do not translate easily to another view; and user modifications to one map do not appear on maps of a different scale or view.

There are alternative technologies such as Flash™ software that do not require vector information to be converted to raster format by the server. This reduces the load on the server and places it on the remote computer. But the configuration of the remote computer is unknown and it may not have the necessary software plug in or may not be powerful enough to render a Flash™ program effectively.

### FIELD OF THE INVENTION

The present invention generally relates to geographic information systems and in particular to geographic location referencing systems and the display of travel routes and user provided information including text and pictures that may be associated with various locations along the route.

### BRIEF SUMMARY OF THE INVENTION

To overcome the limitations in the prior art described above, and to overcome other limitations that will become apparent upon reading and understanding the present specification, the present invention discloses a system and method for enabling a remote user connected to the Internet to create a map based trip journal of their travels.

An embodiment of the system comprises a web based application server in communication with a database of raster based maps; a coordinate system relating the maps to one another; a user interface for preparing and organizing a trip journal; a user interface for choosing and configuring the maps included in the trip journal; and a user interface for creating and editing entries into the trip journal.

The software for systems other than a web browser is designed to run on a web server. The web server can be a standard personal computer configured as a web server using readily available software tools.

The remote user, or traveler, can create an entry into their journal and relate that entry to a position on a selected map. The entry is time stamped and can be annotated by the traveler with textual and pictorial data. Individual entries in the journal are linked according to their time stamp and the resultant information displayed to visitors using the Internet.

The position of a particular journal entry is displayed in the same relative position on all other maps containing that entry regardless of the map's view or scale. As well, the links between individual journal entries (indicated by lines displayed on the maps to show progression from a map location to another map location) are displayed in the same relative position on all other maps containing a position of one of the journal entries (or containing a link between entries), regardless of the view or scale of the map.

Maps are updated in real time as the remote user creates journal entries, deletes journal entries or changes the position and/or date of a particular entry.

The present invention may also comprise an algorithm having inputs of the longitude and latitude of locations which has as its output, the coordinates of the underlying map structure wherein the coordinates of these locations of interest can be displayed on the individual raster maps; and a system for creating the raster based map database from a larger raster map of known size and storing the coordinates and scale for individual maps relative to the larger raster map.

Another embodiment of the method is a method of displaying, on a web page, a trip having at least a first and a second locations, on a plurality of maps, comprising, associating said first and second maps and said first and second locations with a central coordinate system; displaying said first and second locations on a first map; and on receipt of a request to display said second map, displaying said first and second locations on said second map, wherein the relative position of said first and second locations on said first map remains constant relative to said display on said second map.

Another embodiment of a method according to the invention is a method of displaying, on a web page, a trip comprising a plurality of locations, each of said locations associated with a latitude and a longitude, comprising: associating each of said locations with a period of time; ordering said locations on the basis of said period of time; and displaying, on a map displayable at said web page, at least one of said locations with a displayed line connecting said location to the location preceding and following said displayed location according to said order.

Another embodiment of the system is a system for creation and display of trip journals, comprising, a server hosting a web page allowing modification and display of a trip journal associated with a trip to first and second locations, said trip journal comprising first and second maps, said first and second showing at least one of said first or second locations; said server accessible by a first remote computer whereby a traveler may access and modify said trip journal; said server accessible by a second remote computer whereby a visitor may view said trip journal; and wherein the relative position of said first and second locations on said first map remains constant relative to said display on said second map.

A yet another embodiment of the system is a system for creation and display of trip journals comprising, a server in communication with a database of raster based maps; a coordinate system relating each of said maps to a central coordinate system; a user interface for creation and amendment of said trip journal and for selection and modification of a map for inclusion in said trip journal to display a location; and a user interface for creation and amendment of entries associated with said location.

### BRIEF DESCRIPTION OF THE SEVERAL VIEWS OF THE DRAWING(S)

FIG. 1 is a block diagram of a structural overview of an embodiment of the present invention;

FIG. 2 is a block diagram of the exemplary hardware and software of an embodiment of the present invention;

FIG. 3 is a view of an embodiment of a home page with a user interface for the present system;

FIG. 4 is a view of a user interface for registered users (travelers) to log in;

FIG. 5 is a view of a user interface for a traveler to update a trip journal;

FIG. 6 is a view of a user interface with which travelers customize maps;

FIG. 7 is a view of a sample screen shot of a user interface for creation of a new trip journal entry;

FIG. 8 is a view of the relationship between two maps and how they relate to specific points on a central coordinate system.

FIG. 9 is a view of a web page showing the user interface for associating a trip journal entry with a point on a map;

FIG. 10 is a view of a web page showing a trip journal as visitors may see it;

FIG. 11 is a view of a web page showing the same trip journal as seen in FIG. 9, with a different map view selected;

FIGS. 12 and 13 are views of web pages showing a trip journal as seen by a visitor;

FIG. 14 is a view of a web page showing an itinerary of a trip journal;

FIG. 15 is a view of a web page showing the content of an email sent to a visitor;

FIG. 16 is a view of an embodiment of a web site by which entries are made and amended by a traveler;

FIG. 17 is a view of web site showing the interface by which travelers and maps to a trip journal;

FIG. 18 is a view of a web site by which a referral source may register as such with the system;

FIG. 19 is a view of a web site showing a report generated by the system for a referral source; and

FIG. 20 is a view of a web site that may be seen by visitors if the trip journal is password protected.

### DETAILED DESCRIPTION OF THE INVENTION

In the present specification and claims, the following terms will have will have the following meanings:

“location” means a position or site marked by some distinguishing feature, and includes cities, towns and landmarks;

“traveler” means an entity capable of accessing the Internet and creating a trip journal and includes software agents and robots;

“trip” means an act or instance of traveling from one location to another;

“trip journal” means a record, accessible via the Internet, of a trip, which may comprise locations on a map, photos, text, audio and other media.

“visitor” means an entity capable of accessing a trip journal on a web page and includes software agents and robots;

“web page” is a document on the Internet. Every web page is identified by a unique Uniform Resource Locator (URL). A web page is a file readable by web browsers and may contain prompts to the user including common user interface controls such as data entry fields, list boxes, drop-down boxes, check boxes, push buttons, radio buttons and the like. In a preferred embodiment, HTML and XML scripts are used to display the pages and accept data from users via the web browser. Using hypertext, a link is a selectable connection from one word, picture, or information object to another. In a multimedia environment such as the World Wide Web, such objects can include sound and motion video sequences. The most common form of link is the highlighted word or picture that can be selected by the user (with a mouse or in some other fashion), resulting in the immediate delivery and view of another file. The highlighted object is the anchor. The anchor reference and the object referred to, constitute a hypertext link;

“web site” means a unique location on the World Wide Web containing a home web page, and also includes non-computer analogues, like URLs printed into the pixels of paper advertisements;

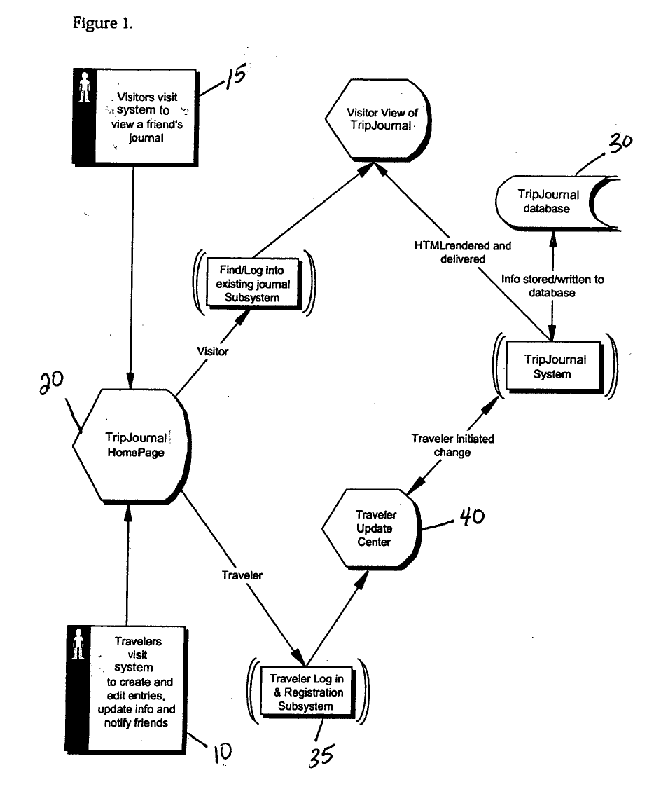

Turning now to the drawings, as seen in FIG. 1 is a block diagram showing a structural overview of a preferred embodiment of the present invention. The disclosed embodiment envisions two classes of users of the system; travelers 10, who use the system create and update a web journal as they travel and visitors 15, who access the system to view the content created by travelers.

A traveler wishing to use the system first visits a website, typically the home web page 20 of the entity operating the system (the “operator”), and registers 35 with the system. Data such as a name, a country of origin and an email address, is collected from the traveler via an online form and is saved to a database 30. The data may also include an address or a telephone number or other information of interest to the operator of the system. The traveler then creates a password to be used for subsequent log ins. Once registered, the traveler, after logging in to the system, can create a trip journal, configure it and add content at the Traveler Update Center 40. Depending upon the operator and the trip journal options selected, payment may be required from the traveler to register with the system using conventional methods. Payment processing may be handled through a third party such as PayPal™.

Typically, the trip journal is initialized at the traveler's home location, prior to the traveler beginning the trip. During the trip, updates will typically be made via Internet connection located in hotels or cafes or through wireless or satellite systems. On logging in (typically with an email address and password), a traveler can then update their preferences, edit existing entries or create new entries. An entry usually consists of text and/or pictures. An entry may also be linked to a location on a map.

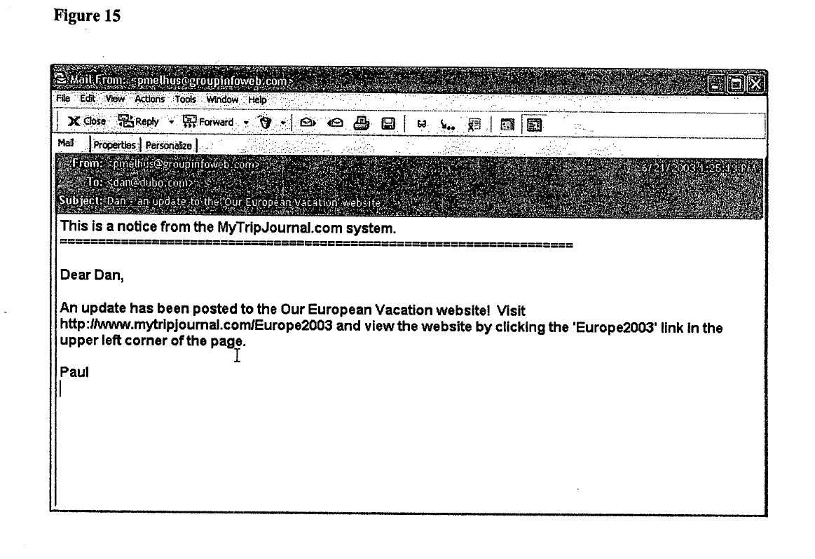

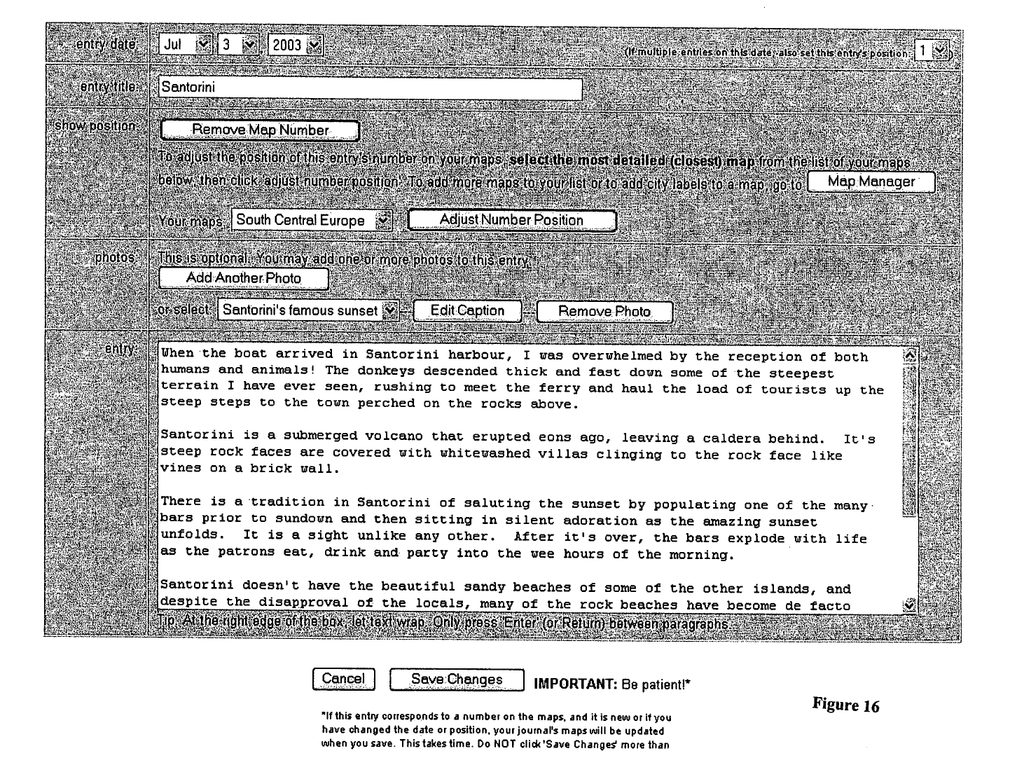

Once a new entry has been saved, the traveler can send a broadcast email to the addresses in the traveler's ‘friends’ list advising that an update to the trip journal has been made as seen in FIG. 15. The email contains a dynamically generated link that takes the visitor to the system operator's home page where a link to the trip journal is displayed prominently.

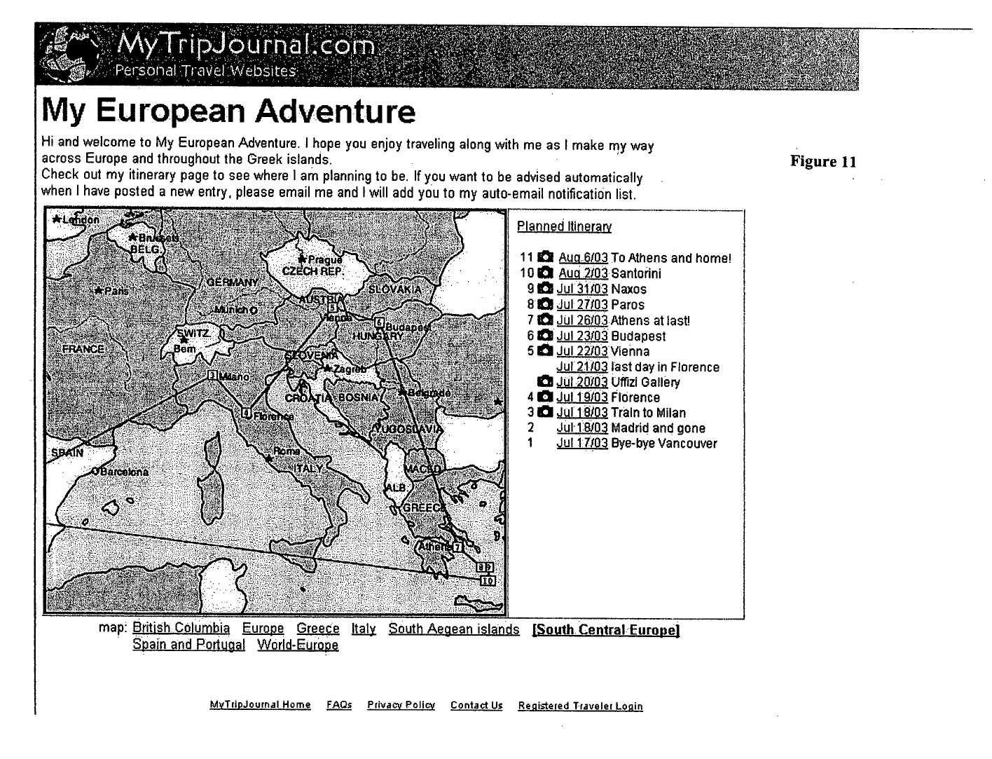

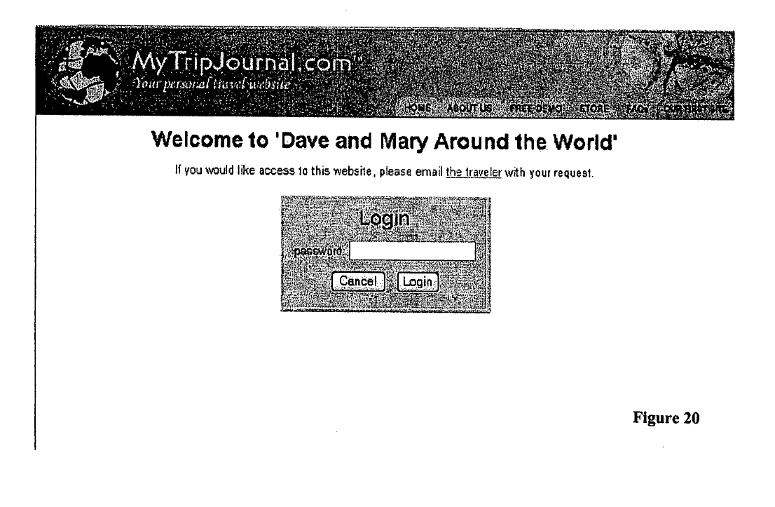

Visitors may view the trip journal by clicking on the link. A visitor may be required to enter a password (as seen in FIG. 20)—if that option has been set by the traveler in which case the traveler (in which case the traveler should also provide the password to those on the “friends” list). Alternately, visitors who simply visit the operator's home page directly can search for a particular trip journal by entering part of its name (as provided by the traveler) into a search box. A list of possible matches is then displayed at the web page, for selection by the visitor. Upon logging in (and using a password if required by the traveler) friends can view the entries in the trip journal (as seen in FIGS. 11, 12 and 13) and send messages to the traveler.

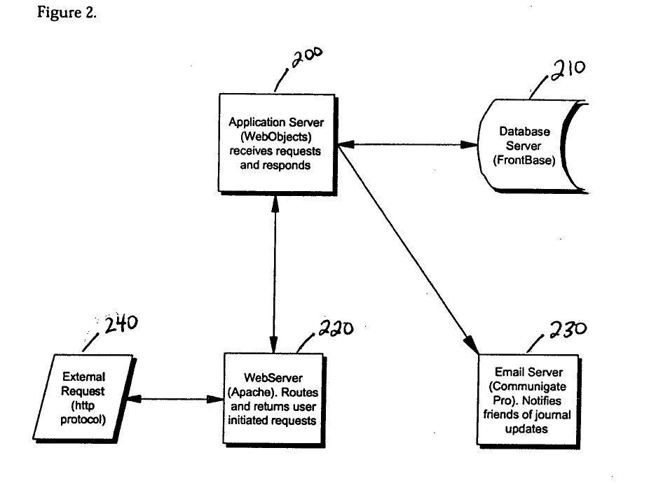

FIG. 2. shows a block diagram of the exemplary hardware and software of the preferred embodiment of the present invention including an application server 200, a database server 210, a web server 220 and an email server 230. The system is in communication with the Internet using the http protocol 240. The embodiment of the system as described here is scaleable. Each component of the system is split off to a separate personal computer if warranted, however the system can run on a minimal set of computer hardware and software.

In one embodiment, the system resides on a single personal computer, running a stable UNIX based operating system such as Apple's™ OS X™. The computer is, at a minimum, preferably a Pentium 3™ running at 2 GHz or a G4 PowerPC™ running at 500 MHz, 512 or more megabytes of RAM and 20 or more gigabytes of available hard disk space. The personal computer is configured as web server 220 using a program such as Apache™ integrated with an application server such as Apple™ WebObjects™ or IBM™'s WebSphere™ but other software known in the art may also be used. All data, except for images are preferably stored in database 30 conforming to the SQL standard. In a preferred embodiment, FrontBase™ from FrontBase Software™ is used as the database 30. Email services are provided by conventional software such as the Communicate Pro™ email software.

The actual system software may be written in Java™, although other programming languages may be used, using much of the built in routines and functionality of the application server 200.

In an embodiment, images are stored on a hard drive as files and served by Apache™. Alternate computing arrangements are widely available and known in the art.

A minimum of an ADSL connection to the Internet is also preferred (although travellers and visitors may use relatively slow connections from Internet cafe's and the like). System load is the primary determinant of the required connection. As traffic volume increases, a higher speed connection is preferable.

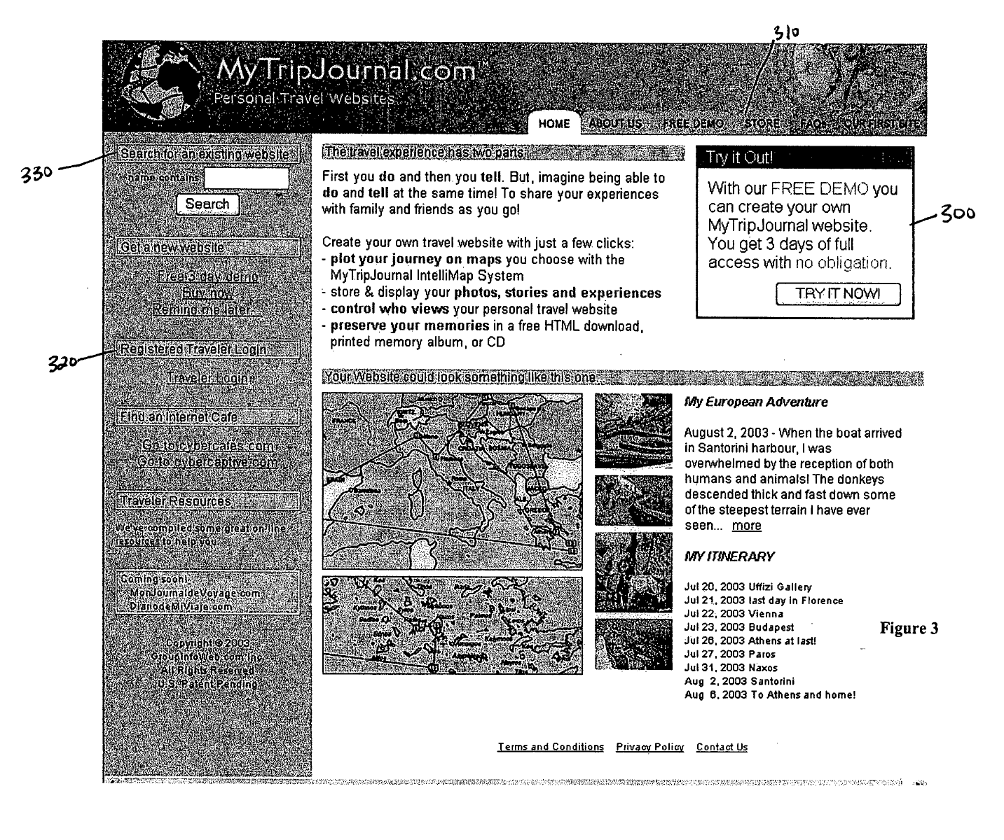

A traveler typically accesses the system via a user interface, preferably a web site as seen in FIG. 3. Visitors to the web site may register up for a ‘Free Demo’ 300, or visit the ‘Store’ 310. Travelers who have already registered can log in by clicking the link in the ‘Registered Traveler Login’ area 320.

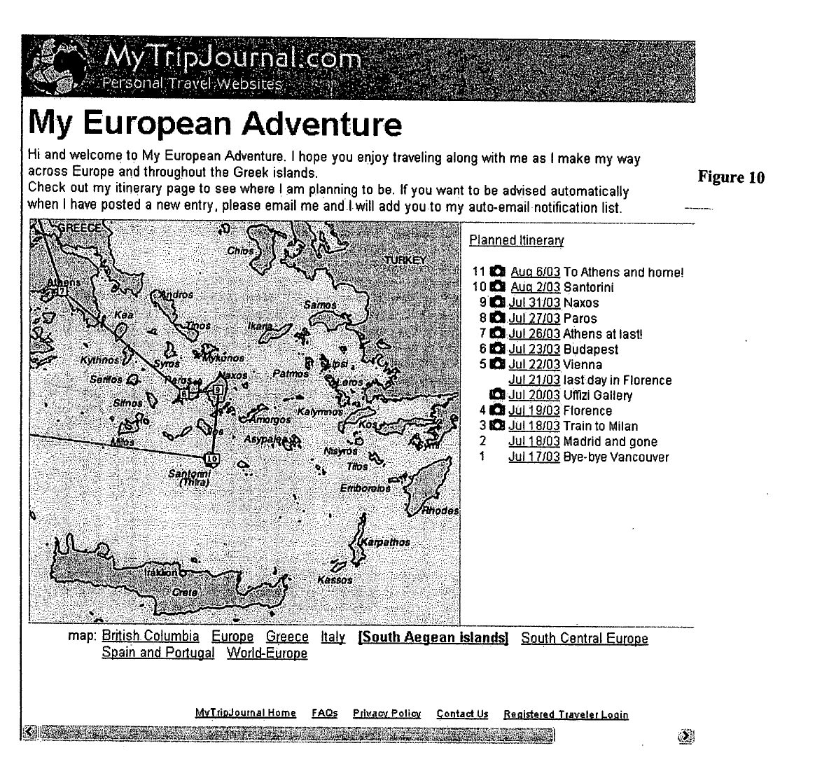

Visitors can search for specific trip journals in the ‘Search for Existing Website’ area 330. If they have arrived at the home page by clicking a specially formatted link in an email from a traveler, the visitor will be led directly to the home web page of the appropriate trip journal as seen in FIG. 10. Alternatively, the visitor could be led to the operator's home page, with the name of the specific trip journal displayed as a link on the web page. The trip journal may require a password in order to gain access to journal entries, as seen in FIG. 20 depending on the options, set by the traveler.

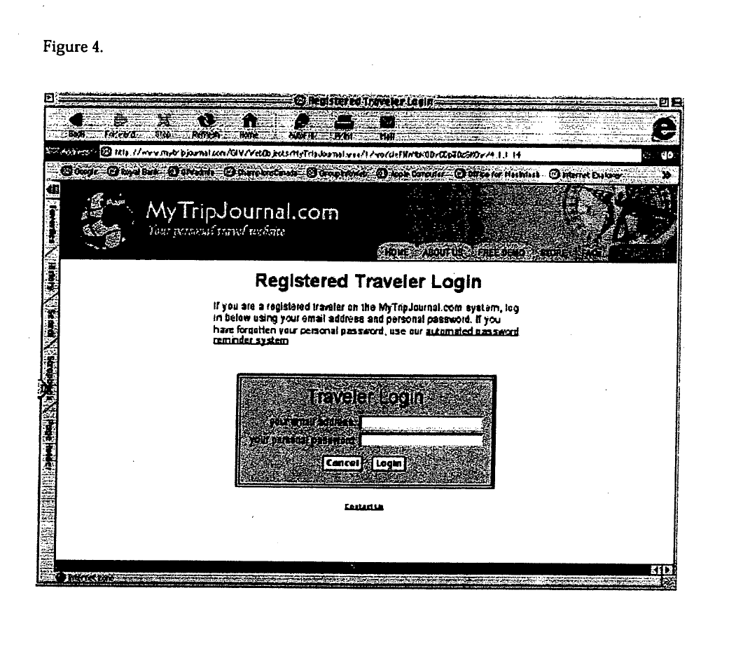

Registered travelers access a user interface web page as seen in FIG. 4 where they log in to maintain their entries and update their trip journals. This web page can be accessed from the home page (as seen in FIG. 3) by clicking the ‘Traveler Login’ link 320. However travelers may also access their trip journal through a link directly to the login page, thereby bypassing the relatively graphics intense home page. The traveler log in screen preferable has minimal graphics, which speeds loading time on slow Internet connections.

After a traveler logs in, a list of the traveler's trip journals (unless there is only one) is displayed. The traveler selects the desired journal from the list. On selecting the trip journal, the system reads the details of the traveler and the specified trip journal from the database and displays an ‘Update Center’ webpage.

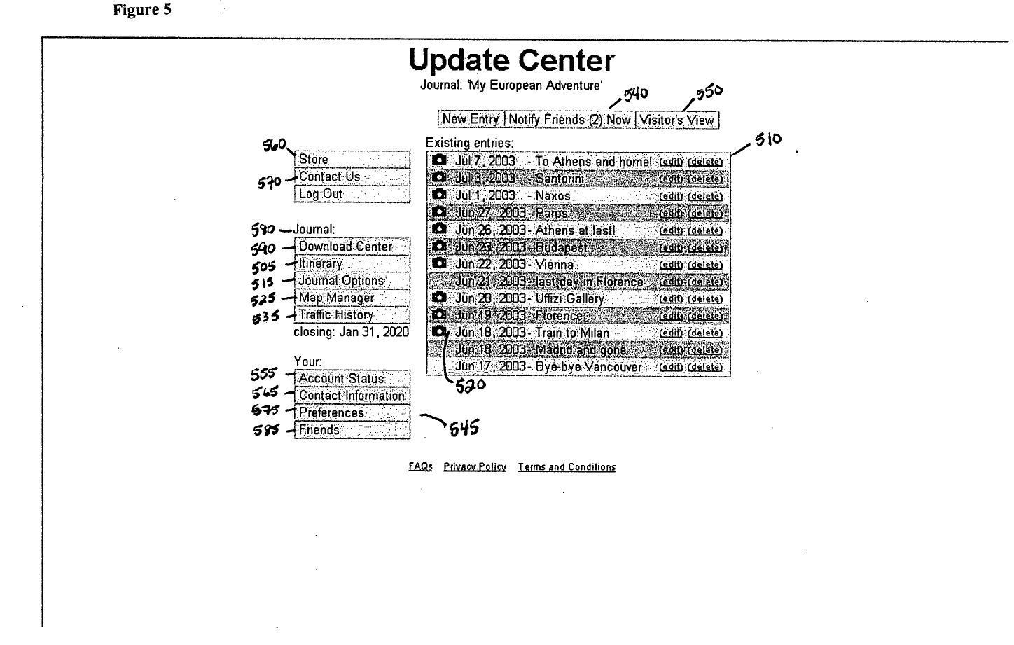

An embodiment of a web page user interface for the travelers ‘Update Center’ is seen in FIG. 5. As an individual traveler may have more than one trip journal, the name of the current trip journal is displayed at the top of the screen. There is preferably a “Help” link (not shown) available at the update center (and throughout the other web pages on the system) whereby the traveler can view pop up windows giving information and hints dependent on the context of the trip journal (for example if the help link is selected from the registration web page, the assistance provided will be relevant to registration). In a preferred embodiment, once a traveler has accomplished a particular task, the help function for that task will not be prominently displayed when the help option is selected (but help on all topics may still be available via searching).

Existing entries for this trip journal are displayed in the box entitled ‘Existing Entries’ 510. Preferably entries are identified by a name assigned by the traveler when they first create the entry. They are typically sorted in date order, or if there is more than one entry on the same date, by a position setting (1, 2, 3 etc.) located on the entry screen. Entries that contain pictures are indicated as such by an icon 520 such as a camera. Existing entries can be edited or removed by clicking the appropriate link.

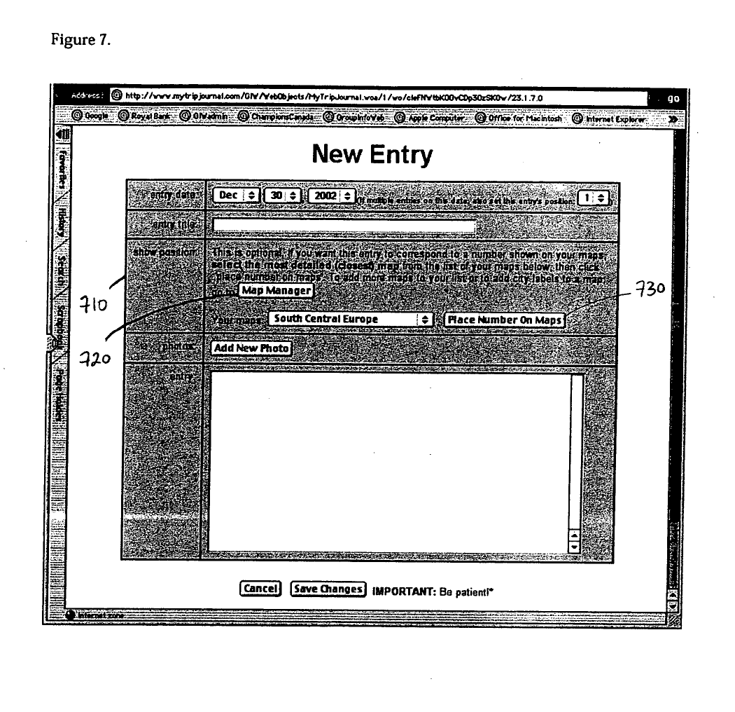

The traveler can create new entries by clicking the ‘New Entry’ link 530. This links the traveler to the ‘New Entry’ web page, an embodiment of which is shown in FIG. 7.

Once the traveler has edited their journal, they may notify visitors by email. This is accomplished by clicking the ‘Notify Friends’ link 540. An email as seen in FIG. 15, is then sent to the email addresses in the ‘Friends’ list. This email contains text stating that an update has been made to the traveler's web journal along with a specially formatted link such as “http://www.operatorname.com/tripname”. Clicking this link will open the home page, with the trip journal name variable displayed as a link. This link may be located in the ‘Search for Existing Website’ area 330. If the traveler requires a password to view their trip journal, a key icon will be displayed next to the trip journal name. As well, a traveler can include the password in the body of the email, if desired. The total number of emails which will be sent is displayed in brackets.

The ‘Visitor's View’ link 550 displays the trip journal to the traveler as it will be seen by the visitors.

The ‘Store’ link 560 opens a web based store and allows the traveler to purchase additional products and services. Items for sale may include a new trip journal, time extensions to existing trip journal and a service whereby the system will store pictures in their original format, as well as a standard optimized form. Alternatively availability to a trip journal can be sold in bundles with a certain package of features available to a traveler for a certain period of time (for example 90 or 180 days) for a particular price. Of course short demos with limited features may be provided at no charge, or in an alternative embodiment the trip journal could be advertiser supported.

The ‘Contact Us’ link 570 opens a web page with details on how to get in touch with the operator's staff.

Items located in the ‘Journal:’ section 580 of the update center relate specifically to the current trip journal and have no effect on other trip journals that the traveler might have. ‘Download Center’ 590 allows the traveler to download the current trip journal and, possibly, any saved photos in their original resolution. When the traveler chooses to download their current trip journal, the system reads in the content of the trip journal—text, photos, maps, etc. and translates it into a set of static html files. These are then sent through http protocol to the traveler's local hard drive for archiving and viewing at the traveler's convenience.

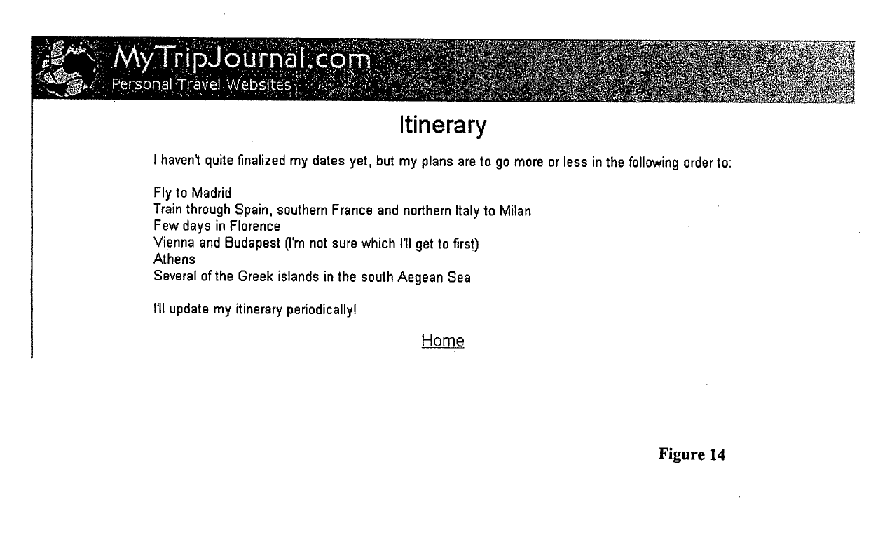

Clicking ‘Itinerary’ 505 opens a form where the traveler may enter a textual description of their planned itinerary, as seen in FIG. 14. This information is saved into the journal database. This itinerary may later be changed by the traveler.

Clicking ‘Journal Options’ 515 allows the traveler to set the access name visitors will use to access the trip journal. This access name is appended to the end of the URL in the email sent when the traveler clicks ‘Notify Friends’. Alternately, visitors can search for this trip journal access name from the ‘Login to Existing Journal’ search function located on the home page. If the traveler chooses, a password can be required to view the trip journal as seen in FIG. 20. This password is specified here. The traveler can also type the name of the trip and a welcome message that will be displayed on the trip journal's home page.

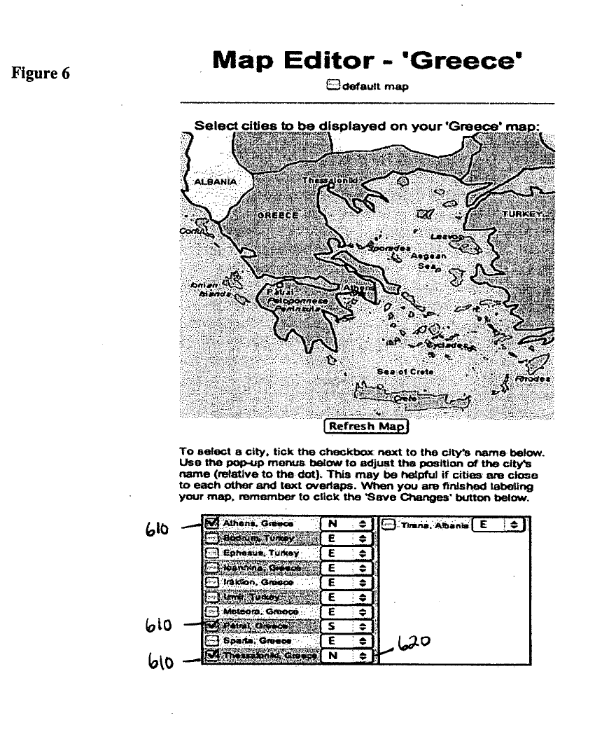

The ‘Map Manager’ 525 allows the traveler to view and add maps to the journal. As well, the selected maps can be customized to add or remove cities and the positioning of the city name. See FIGS. 6, 9 and 17 for further detail. ‘Traffic History’ 535 displays information about the visitors to the trip journal, such as a graph of the number of visitors to the trip journal. This graph typically may contain up to one year of history.

Items located in the ‘Your:’ section 545 relate specifically to the traveler and affect all trip journals that the traveler might have.

Clicking ‘Account Status’ 555 leads to a web page displaying the trip journals which the traveler has created and their current status. In a typical embodiment a journal can have three states. The first state is “Active”. Active journals are displayed as links from the ‘Account Status’ web page and are fully editable. New entries are permitted. A second state is “Closed”. Closed journals cannot be edited and allow no new entries. A closed journal can become active (for example if the traveler chooses to purchase additional time). A third state is “Expired”. Expired journals have had all the content removed and cannot be changed or made active.

Clicking ‘Contact Information’ 565 links to a web page displaying an editable form containing the traveler's information. Fields may include first name, last name, address, country, email address and telephone number.

The ‘Preferences’ link 575 leads to a web page allowing the traveler to change the password used to access the journal. As well, a traveler can specify whether the optional visitor password is to be included in update emails to “friends”.

The ‘Friends’ 585 link leads to a web page allowing the traveler to add new and edit existing email addresses on their “friends” list. A search function is also provided to facilitate searching for existing addresses. Searchable fields may include first name, last name and email address.

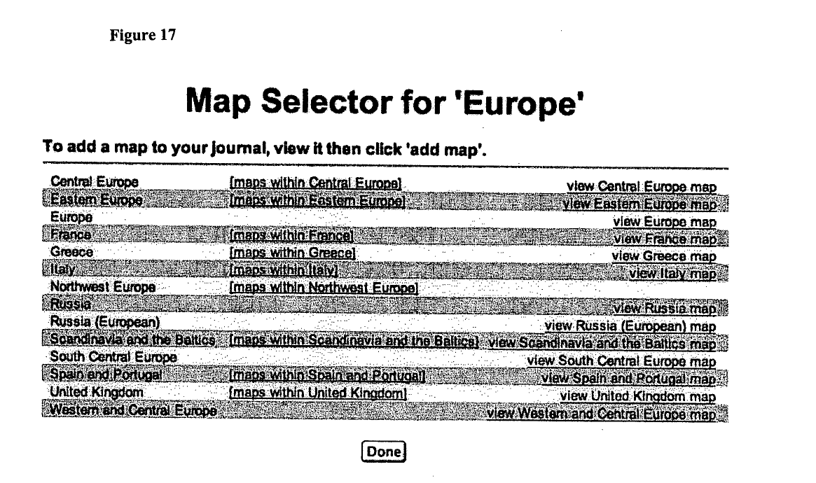

A user interface is used by travelers to customize their maps, as seen in FIG. 6. Once a map has been added to a trip journal from the database of available maps it is available for editing. From the ‘Map Manager’ the traveler can select the desired map from a list, as seen in FIG. 17, and clicks ‘Edit’. The checked cities 610 appear on the map as dots with the text positioned according to the direction specified 620. Adding and removing cities may be accomplished by clicking or un-clicking the appropriate check box. The position of the city name on the map may be changed by choosing from a pop up list. Available positions include the compass directions N, NE, E, SE, S, SW, W and NW. This feature allows the traveler to create a more readable map, as they can avoid having text that runs into other map elements such as another city and/or city name, a river or a country boundary. The traveler can also set a map to be the default map shown when visitors view the trip journal. The visitor may override this default map.

FIG. 7. shows a sample screen shot of a user interface by which a traveler can create a new trip journal entry. An entry may include an entry date, entry title and/or descriptive text about the entry. The entry title is used as the link, which visitors will click on when they view the trip journal.

The ‘Show Position’ 710 feature is optional. It allows the traveler to have this entry correspond to a number shown on their maps. The traveler preferably selects the most detailed (closest) map from the list of maps in the pop up list for this purpose. Additional maps can be added the pop up list by clicking the ‘Map Manager’ link 720.

Digital photographs to be associated with this entry and viewed by visitors, can also be uploaded. In this embodiment both .jpg and .gif graphic formats are supported although other file formats may be used. After the image is uploaded, the system may create a thumbnail of the image and auto-optimize the image. In a preferred embodiment, travelers may be able to manipulate the images using the system. For example, travelers may be able change the orientation of the images. Other means of manipulating the images may be available, such as adjusting the brightness, etc.

If the traveler has created multiple entries on a particular date, the entry's position (1, 2, etc.) can also be selected. Multiple entries are displayed in the ‘Update Center’ and a visitor views the entries as a reverse ordered list, therefore the most recent entry will be likely the first to be viewed by visitors.

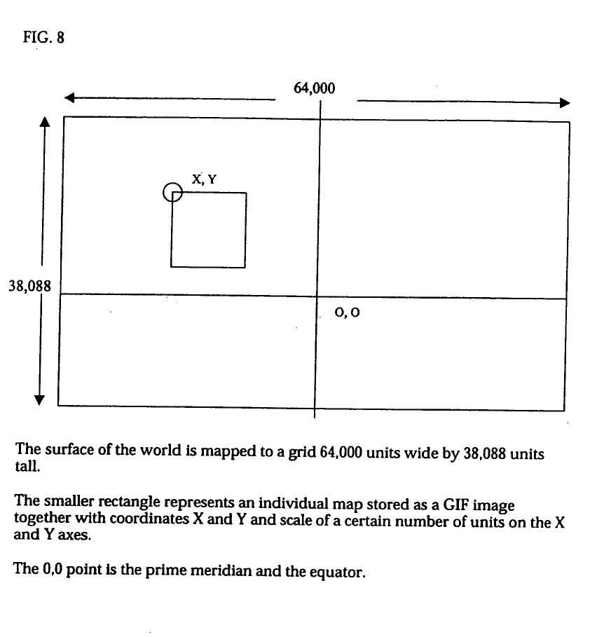

The system relates individual maps and specific points on the maps to a central coordinate system, as shown in FIG. 8.

The central coordinate system in a preferred embodiment is a grid 64,000 units wide by 38,088 units high. These dimensions allow a “Standard Simple World Mercator” map to be represented with reasonable precision. The extreme north and south areas, where the most Mercator distortion occurs, may be trimmed off. As these areas, such as the north and south poles, are less likely to be visited by travelers, there is little lost if they are not in the system. The X origin may be placed at 0 degrees on a Mercator map—the prime meridian located at Greenwich, England. The Y origin may be placed at the equator. Due to the manner in which the trimming is done, this results in an origin is 25,216 units from the top of the grid.

Each map is associated to the master grid system and scale. In order to reduce the load on the application server, a trip journal's maps, with traveler modifications of such maps are generated as image files such as GIF files, and subsequently sent to travelers and visitors by the server. Maps are preferably regenerated whenever entries containing map positions are added or removed, or when an entry's map position or date is adjusted.

As previously discussed, a traveler can select from a large selection of available maps, then customize the map with cities and city labels. In an embodiment of the system, the maps are provided by the operator of the system. The maps are created by selecting portions of the central coordinate system to appear as a separate map (for example a specific country, state or the like). Cities (or other landmarks) are selected as defaults. When a new map is created, some cities may already be present if they have been recorded with an overlapping map. Others may be specific to the new map. Any new cities will be kept in the database where they can be located via searching and associated with other maps covering the same location. All cities and landmark records include the latitude and longitude of the location. Borders and shorelines of maps are treated differently as when apparent on the central coordinate map, they appear as very large and have little detail. Therefore when creating a map with a smaller scale, the borders and shorelines must be shrunk, and detail may have to be added.

The system also contains a database of cities, each having an X, Y coordinate on the central coordinate system grid. These city records and their coordinates can be determined using publicly available figures for latitude and longitude.

In the described embodiment, the conversion of longitude to the central coordinate system X coordinates is exact, given the size of the grid, and is accomplished using the following formula:

X=(degrees of longitude)*64000/360

The conversion of latitude to the central coordinate system Y coordinates is an approximation, but is sufficiently accurate given the resolution of the underlying grid (64,000 pixels×38,088 pixels) and that extreme points such as the North Pole and Antarctica are not included. Conversion is accomplished using the following formula:

Y=log (tan (π/4+(radians of latitude)/2))

(Note: use natural log (base e))

Inputs of longitude should include degrees (to three decimal places) from the prime meridian, with west represented as a negative number and east represented as a positive number.

Inputs of latitude should include degrees (to three decimal places) from the equator, with north represented as a positive number and south represented as a negative number.

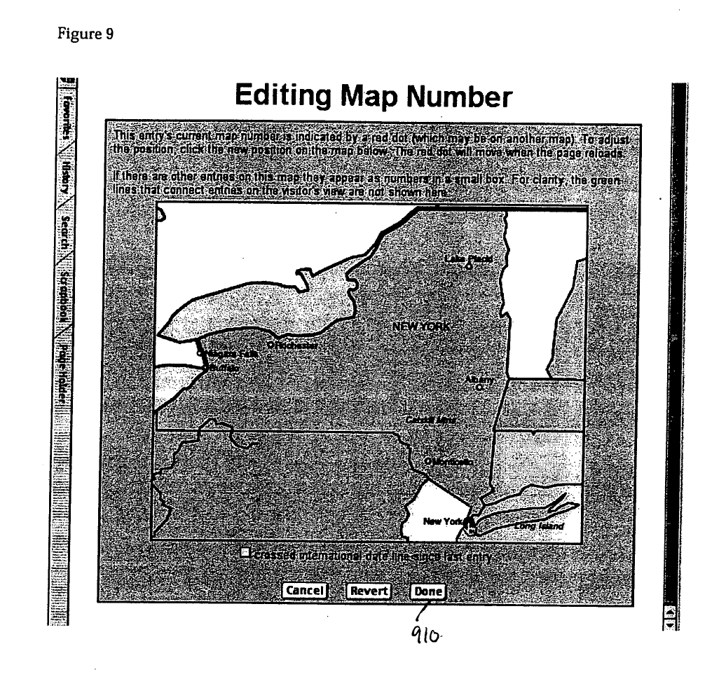

Travelers may associate an entry with a point on a map as seen in FIG. 9. This web site appears after the user clicks the ‘Place Number on Maps’ link 730, as seen in FIG. 7. Using a pointing device, such as a computer mouse, the traveler locates the desired position on the map and clicks a mouse button. A number of locations such as cities or landmarks are listed at the bottom of the web site. The default list of cities are those selected by the operator to be the most likely destinations. These cities may appear on the map (depending on the scale of the map). For example, Rome may be the only Italian city to appear in a map of western Europe including Italy. However, a map of Italy would include a number of other cities, such as Venice, Florence, and Genoa.

In FIG. 9, the traveler has clicked on New York City on the New York State map. This action sends a signal back to the server with the coordinates of the click. Software running on the server translates these coordinates to the central coordinate system. In this example, the X coordinate for New York is 13, 143 and the Y coordinate is 7,948.

When the ‘Done’ button 910 is clicked, software running on the server regenerates the other selected maps that contain this coordinate with the new point and any lines that connect to this point. The updated maps are saved on the server as image files and the obsolete map files may be deleted.

Note that a traveler may also select a point on the map for an entry that is not associated with a city. Alternatively the traveler can select a point by providing a latitude and longitude. In these cases, the traveler may label the point as desired. For example, by providing the name of a town or landmark.

Alternatively the traveler can search a database of cities and landmarks by name. Each city or landmark is associated with its latitude and longitude and once selected will appear in the city menu portion of the web page and on the map. Cities may be deselected by clicking a checked city from the city menu.

FIG. 10 shows a sample web page of a trip journal as visitors would see it. FIG. 11 shows a view of the same journal as in FIG. 9, with a different map view selected. Note that the relative position of the map number points and the lines connecting them remain constant.

The lines are inserted automatically by the system based on the dates of the visited locations. In alternative embodiments of the inventions the traveler can further specify the mode of travel (for instance by road, rail, air or sea) and select the path taken (for example the highway note). In this case the database must have additional information about transportation links, for example the highway system or rail system to provide information. In one embodiment, the system could be in communication with airlines or boat/sea to obtain the actual flight paths taken by the traveler. This would allow for a more precise display of the route taken by the traveler.

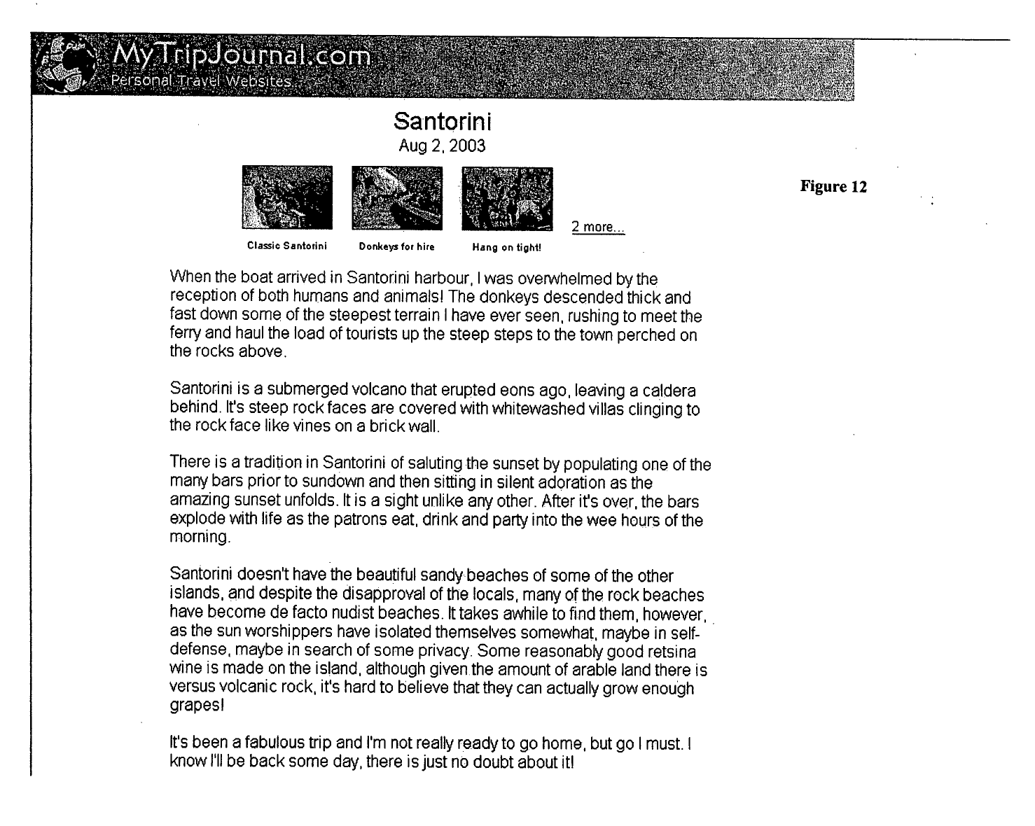

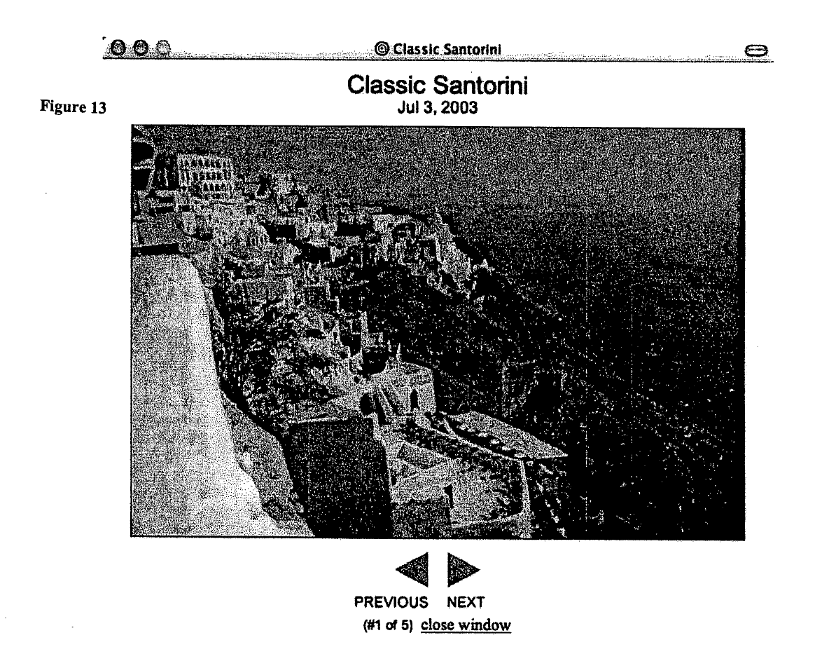

FIG. 12 shows a view of the text from an entry as seen by a visitor. From this page the visitor can link to photographs as seen in FIG. 13.

The system may include a message system whereby visitors can leave text messages (possibly with attachments) for a traveler. These messages may be public, for all visitors and the traveler to view, or they may be private, so that only the traveler can view the messages. In one embodiment, the messages may initially only be viewed by the traveler. The traveler then has the option of maintaining the message as private, or marking as public for viewing by other visitors. The traveler also has the option of deleting or responding to the message.

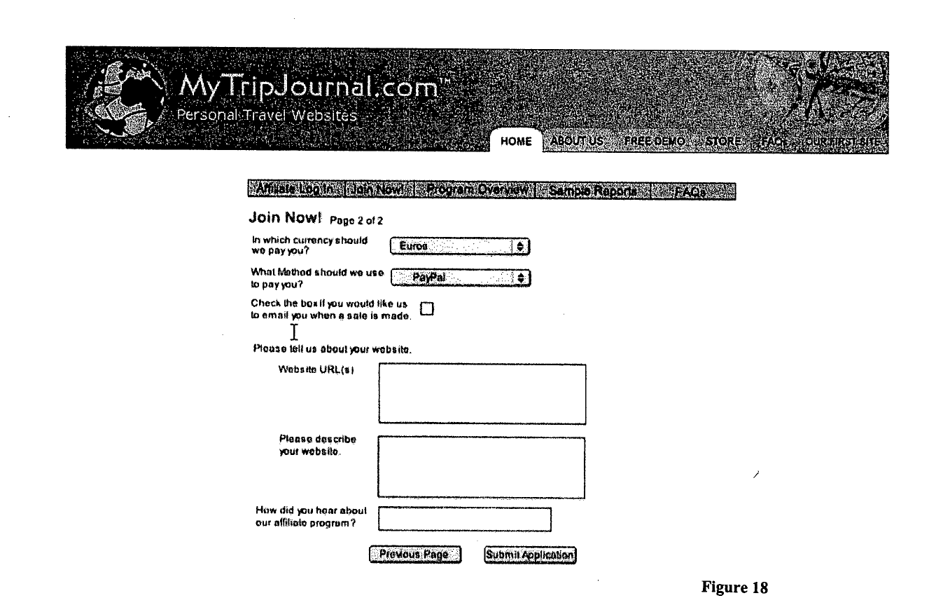

The database used by the system can also be used for creating and managing a referral base for drawing potential travelers to the system. The referrals can be managed as is traditionally done, through links from the referral source's web site after the referral source has registered (through a web site as seen in FIG. 18). The URL in these links are tagged so that the referral source can be identified. As a new user referred by such a link is more likely to register for a free service (such as a demonstration) rather than pay immediately for use of the system, when the referred user signs up for a demonstration the record associated with the user includes a reference to the referral source.

Other means of tracking referral sources include the use of promotional codes, wherein if the user enters such a code the appropriate referral source can be credited. This can also be used to track the success of various advertising media (or salespeople) by using different codes for each medium.

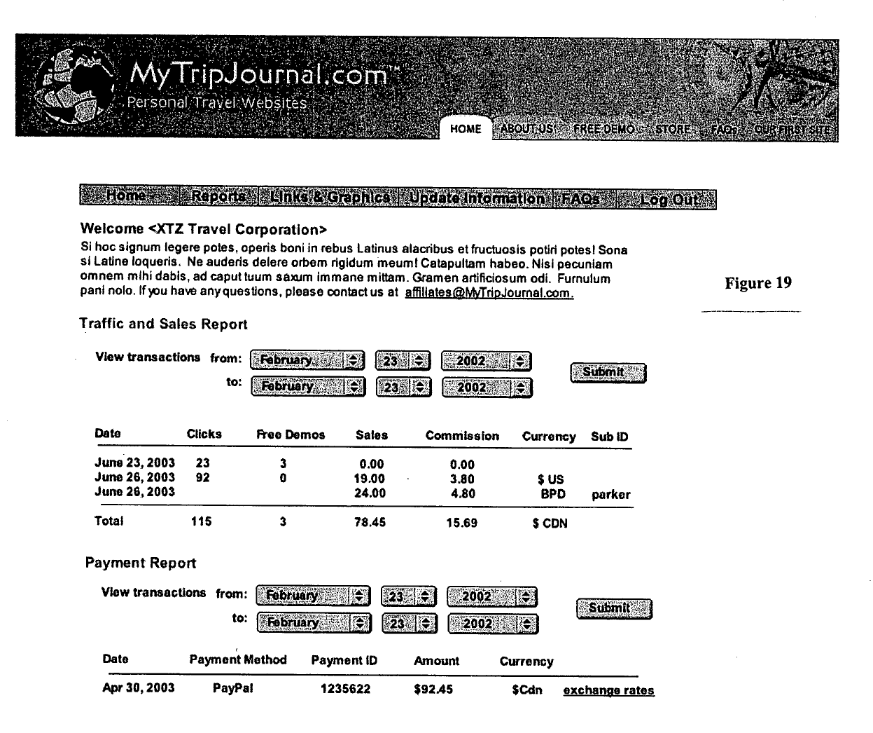

As the record associated with each user who becomes a traveler includes an association with a particular referral source, it is possible for the referral sources to monitor sales very closely by logging in to the system and requesting a report (a sample of which is seen in FIG. 19). The system will track amounts due to the referral source, so that when a traveler makes a payment, the system will check if they are associated with a referral source. If so, the appropriate referral source can be immediately credited.

Although the particular preferred embodiments of the invention have been disclosed in detail for illustrative purposes, it will be recognized that variations or modifications of the disclosed apparatus lie within the scope of the present invention.

The invention claimed is:

1. A method of displaying, on a web page, a trip having at least a first and a second location, on a plurality of maps, comprising,
(a) associating said first and second maps and said first and second locations with a central coordinate system;
(b) displaying said first and second locations on a first map;
(c) on receipt of a request to display said second map, displaying said first and second locations on said second map, wherein the relative position of said first and second locations on said first map remains constant relative to said display on said second map.

2. The method of claim 1 wherein said first and second map are related to a central coordinate system.

3. The method of claim 2 wherein locations displayed on said first map are associated with said second map and said central coordinate system by a latitude and longitude associated with said location.

4. The method of claim 3 wherein said latitude and longitude are converted to Y and X coordinates, respectively on said central coordinate system.

5. The method of claim 4 wherein a plurality of default locations are selectable for inclusion on said first map.

6. The method of claim 5 wherein additional locations are selectable for addition to said first map.

7. A method of displaying, on a web page, a trip comprising a plurality of locations, each of said locations associated with a latitude and a longitude, comprising:
(a) associating each of said locations with a period of time;
(b) ordering said locations on the basis of said period of time;
(c) displaying, on a first map displayable at said web page, at least one of said locations with a displayed line connecting said location to the location preceding and following said displayed location according to said order.

8. The method of claim 7 further comprising associating a text message with at least one of said locations.

9. The method of claim 8 further comprising associating a photo with at least one of said locations.

10. The method of claim 7 wherein a second map showing at least one of said locations is selectable, wherein the relative position of said locations on said first map remains constant relative to said display on said second map.

11. A system for creation and display of trip journals, comprising,
(a) a server hosting a web page allowing modification and display of a trip journal associated with a trip to first and second locations, said trip journal comprising first and second maps, said first and second showing at least one of said first or second locations;
(b) said server accessible by a first remote computer whereby a traveler may access and modify said trip journal;
(c) said server accessible by a second remote computer whereby a visitor may view said trip journal;
(d) wherein the relative position of said first and second locations on said first map remains constant relative to said display on said second map.

12. The system of claim 11 wherein said trip journal further comprises an entry associated with said first location.

13. The system of claim 12 wherein said trip journal is accessible to visitors.

14. The system of claim 13 wherein said entry comprises a text message.

15. The system of claim 14 wherein said entry further comprises a photo.

16. The system of claim 15 wherein after modification of said trip journal, said traveler may send a message to said visitor.

17. The system of claim 16 wherein said trip journal is password protected.

18. A system for creation and display of trip journals comprising,
(a) a server in communication with a database of raster based maps;
(b) a coordinate system relating each of said maps to a central coordinate system;
(c) a user interface for creation and amendment of said trip journal and for selection and modification of a map for inclusion in said trip journal to display a location; and
(d) a user interface for creation and amendment of entries associated with said location.

19. The system of claim 18 wherein said entries comprise text messages.

20. The system of claim 19 wherein said entries further comprise photos.

21. The system of claim 20 further comprising means for tracking referrals such that when a traveler is referred to said system, said system records the referral source associated with said traveler when said traveler registers with said system.
